(19) United States
(12) Patent Application Publication
(10) Pub. No.: US 2018/0183695 A1
(43) Pub. Date: Jun. 28, 2018

(54) PERFORMANCE MONITORING

(71) Applicant: Intel Corporation, Santa Clara, CA (US)

(72) Inventor: Michael Hebenstreit, Albuquerque, NM (US)

(21) Appl. No.: 15/392,221

(22) Filed: Dec. 28, 2016

(51) Int. Cl. H04L 12/26

(52) U.S. Cl. CPC H04L 43/0876; H04L 43/106; H04L 43/16

(57) ABSTRACT

Particular embodiments described herein provide for a network element that can be configured to send a collective process to a plurality of nodes, receive data related to the plurality of nodes after the collective process is completed, and analyze the data related to the plurality of nodes to determine if one or more nodes satisfies a predetermined condition. The data related to the one or more nodes that satisfied the predetermined condition can be combined with previously received data related to previous one or more nodes that satisfied the predetermined condition to determine patterns, such as a node consistently being a last node to complete a task.

### TECHNICAL FIELD

This disclosure relates in general to the field of computing, and more particularly, to performance monitoring.

### BACKGROUND

High-performance computers are built of many processors/cores connected by a network and are often used for distributed computing. Distributed computing is a model in which components of a system are shared among multiple computers to improve efficiency and performance. Application performance depends on good use of the network. In some larger systems, it can be difficult to determine when a specific device is consistently last to complete a task or calculation and thus, is slowing down the entire distributed computing system.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for performance monitoring, in accordance with an embodiment of the present disclosure;

FIG. 2 is a simplified block diagram of a communication system for performance monitoring, in accordance with an embodiment of the present disclosure;

FIG. 3 is a simplified table illustrating example details of a communication system for performance monitoring, in accordance with an embodiment of the present disclosure;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment; and

FIG. 6 is a simplified flowchart illustrating potential operations that may be associated with the communication system in accordance with an embodiment.

The FIGURES of the drawings are not necessarily drawn to scale, as their dimensions can be varied considerably without departing from the scope of the present disclosure.

### DETAILED DESCRIPTION

The following detailed description sets forth example embodiments of apparatuses, methods, and systems relating to a communication system for enabling a collective communication operation. Features such as structure(s), function(s), and/or characteristic(s), for example, are described with reference to one embodiment as a matter of convenience; various embodiments may be implemented with any suitable one or more of the described features.

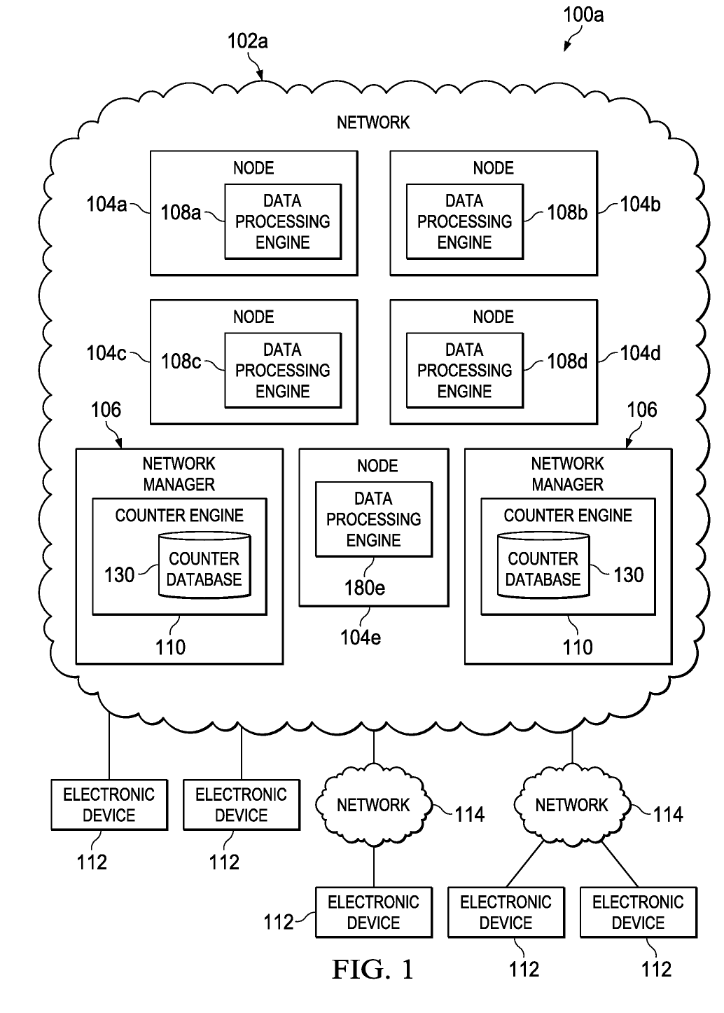

FIG. 1 is a simplified block diagram of a communication system 100a for performance monitoring, in accordance with an embodiment of the present disclosure. As illustrated in FIG. 1, communication system 100a can include a network 102a. One or more electronic devices 112 may be connected to network 102a. In addition, one or more secondary networks 114 may be connected to network 102a and one or more electronic devices 112 may be connected to secondary network 114. Network 102a can be configured to enable high performance computing and the use of parallel processing.

Network 102a can include a plurality of nodes 104a-104e and one or more network managers 106. Each node 104a-104e can include a data processing engine 108a-108e. For example, node 104a can include data processing engine 108a, node 104b can include data processing engine 108b, node 104c can include data processing engine 108c, node 104d can include data processing engine 108d, and node 104e can include data processing engine 108e. Network manager 106 can include a counter engine 110. Counter engine 110 can include counter database 130. One or more nodes 104a-104e can be configured to participate in a parallel processing project that involves a group of processes. The term “project” refers to a collective job, task, operation, program, etc. The term “process” and “collective process” refers to a function, task, one or more calculations, unit of work, etc. performed during a project.

Data processing engines 108a-108e can each be configured to process data related to performance monitoring of nodes 104a-104e. In an example, each data processing engine 108a-108e can help determine the last node to complete a process. In another example, each data processing engine 108a-108e can help determine when a condition is satisfied, or not satisfied, at a particular node or nodes. For example, the condition can include when a node associated with a data processing engine (e.g., node 104a is associated with data processing engine 108a) receives, or does not receive, a specific type of command, flag, indicator, etc., when traffic at a node exceeds or does not exceed a threshold, or some other type of condition is satisfied, or not satisfied. The data or information that helps to determine when the condition is satisfied or not satisfied is data that is specifically related to the node and not data that is specifically related to the collective communication. For example, the data may be related to the performance of the node, a condition of the node, a flag received or not received by the node rather than input or data that is used by the node to perform the collective communication operation. Note that a flag, some other indicator, or condition can be part of the collective communication operation but can also be considered as data related to the node itself. For example data related to the node may be considered level 1 data related to the operation of the node while the data related to the collective communication operation may be considered level 2 data related to a process or job being performed by network 102a or 102b.

Network manager 106 can be configured to use counter engine 110 to gather data related to performance monitoring for each node 104a-104e and store the data in counter database 130. In a particular example, the data may be related to a last node to complete a process. The data related to performance monitoring for each node 104a-104e can be stored in counter database 130.

Elements of FIG. 1 may be coupled to one another through one or more interfaces employing any suitable connections (wired or wireless), which provide viable pathways for network (e.g., network 102a, etc.) communications. Additionally, any one or more of these elements of FIG. 1 may be combined or removed from the architecture based on particular configuration needs. Communication system 100a may include a configuration capable of transmission control protocol/Internet protocol (TCP/IP) communications for the transmission or reception of packets in a network. Communication system 100a may also operate in conjunction with a user datagram protocol/IP (UDP/IP), InfiniBand remote direct memory access (RDMA), InfiniBand verbs, Direct Access Programming Library (DAPL), Performance Scaled Messaging (PSM) or any other suitable protocol where appropriate and based on particular needs. Messages through network 102a or fabric could be made in accordance with various network protocols including but not limited to (e.g., Ethernet, Infiniband, Omni-Path, remote direct memory access (RDMA), direct access programming library (DAPL), performance scaled messaging (PSM), etc.). High-performance computers are built of many processors/cores connected by a network (e.g., network 102a or 102b), often called a “fabric.”

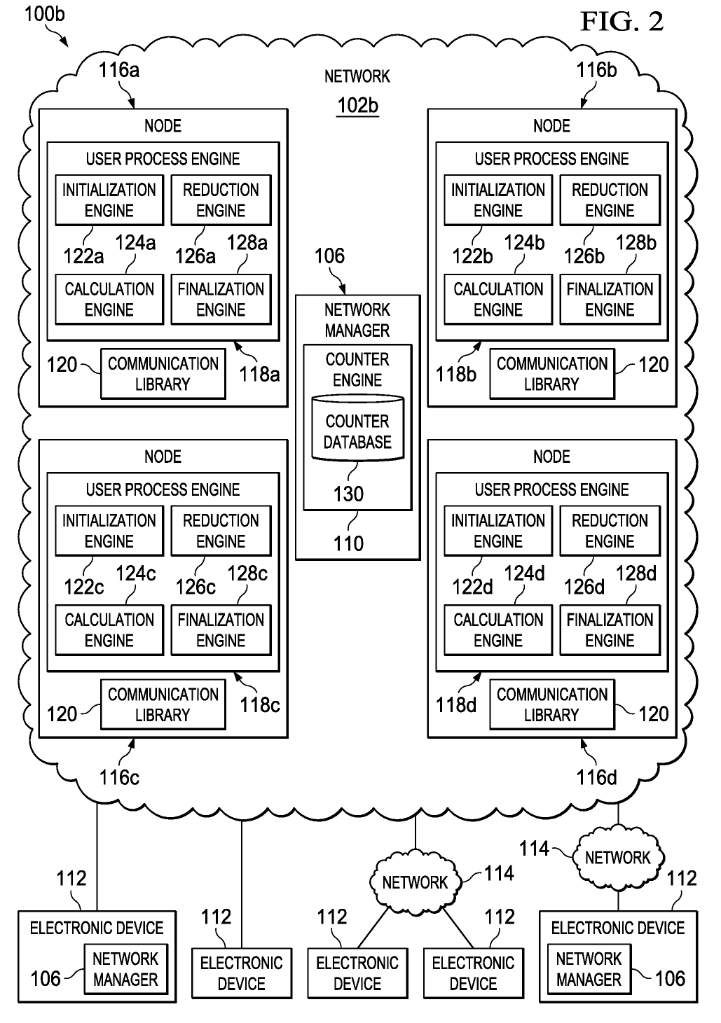

Turning to FIG. 2, FIG. 2 is a simplified block diagram of a communication system 100b for performance monitoring, in accordance with an embodiment of the present disclosure. As illustrated in FIG. 2, communication system 100b can include a network 102b. One or more electronic devices 112 may be connected to network 102b. In addition, one or more secondary networks 114 may be connected to network 102b and one or more electronic devices 112 may be connected to secondary network 114. In an example, one or more electronic devices 112 can include a network manager 106. Network 102b may be configured to enable high performance computing and the use of parallel processing.

Network 102b can include a plurality of nodes 116a-116d. Node 116a can include a user process engine 118a and a communication library 120. User process engine 118a can include an initialization engine 122a, a calculation engine 124a, a reduction engine 126a, and a finalization engine 128a. Node 116b can include a user process engine 118b and communication library 120. User process engine 118b can include an initialization engine 122b, a calculation engine 124b, a reduction engine 126b, and a finalization engine 128b. Node 116c can include a user process engine 118c and communication library 120. User process engine 118c can include an initialization engine 122c, a calculation engine 124c, a reduction engine 126c, and a finalization engine 128c. Node 116d can include a user process engine 118d and communication library 120. User process engine 118d can include an initialization engine 122d, a calculation engine 124d, a reduction engine 126d, and a finalization engine 128d.

Each initialization engine 122a-122d can be configured to perform an initialization related to a specific project and/or process for their respective node 116a-116d (e.g., initialization engine 112a is associated with node 116a). Each calculation engine 124a-124d can be configured to perform the process for their respective node 116a-116d (e.g., calculation engine 124b is associated with node 116b). Each reduction engine 126a-126d can be configured to perform the reduction of the data created by the calculation engine or received data for involved nodes 116a-116d (e.g., reduction engine 126c associated with node 116c and may receive data from nodes 116a and 116d and perform a reduction on the received data). Each finalization engine 128a-128d can be configured to perform the finalization of the data for their respective node 116a-116d (e.g., finalization engine 128d is associated with node 116d)

Communication library 120 provides a standardized application interface allowing an exchange of messages between processes running on the same or different nodes. These messages can be short (e.g., zero, one or more bytes, etc.), or long (e.g., several gigabytes or more). The messages may also be one sided (send), two sided (send/receive), one to one, one to many, or many to one. Communication library 120 can provide similar services for multiple processes or projects running on network 102b. Changes to communication library 120 will not break the running of existing processes or projects, though it might impact performance or create new capabilities within network 102b. Examples of communication library 120 can include parallel virtual machine (PVM), message passing interface (MPI), GPI, or other similar libraries that can help enable communication systems 100a and 100b.

Elements of FIG. 2 may be coupled to one another through one or more interfaces employing any suitable connections (wired or wireless), which provide viable pathways for network (e.g., network 102b, etc.) communications. Additionally, any one or more of these elements of FIG. 1 may be combined or removed from the architecture based on particular configuration needs. Communication system 100b may include a configuration capable of transmission control protocol/Internet protocol (TCP/IP) communications for the transmission or reception of packets in a network. Communication system 100b may also operate in conjunction with a user datagram protocol/IP (UDP/IP), InfiniBand remote direct memory access (RDMA)/verbs protocol, openfabrics interfaces (OFI) protocol, or any other suitable protocol where appropriate and based on particular needs. Messages through network 102b or fabric could be made in accordance with various network protocols including but not limited to (e.g., Ethernet, Infiniband, Omni-Path, remote direct memory access (RDMA), direct access programming library (DAPL), performance scaled messaging (PSM), etc.).

For purposes of illustrating certain example techniques of communication systems 100a and 100b, it is important to understand the communications that may be traversing the network environment. The following foundational information may be viewed as a basis from which the present disclosure may be properly explained.

Application performance of the network during a project often depends on good use of the network. However, it can be difficult to determine if a network element is consistently slowing down operations. For example, some high performance computers include thousands of single servers connected by one or more fabrics. Administration and use of such clusters is complicated by the fact that a slowdown of a single node will directly affect the performance of the whole system. For example, a project or calculation may span or include one-hundred (100) nodes, which is rather on the small side for a project or calculations used in a parallel computing system (e.g., weather forecast). If, out of those 100 nodes, even a single node slows down by about five percent, then the whole project or calculation will be impacted and be about five percent slower. Taking only good nodes, the same calculation on ninety-five nodes can achieve at the same speed. Therefore, for a high-performance computer cluster, it can be critical that all nodes meet a performance criteria (e.g., complete a task or process within a predetermined amount of time or within a time that is consistent with other nodes in the system). Unfortunately, ensuring that each node meets the performance criteria can not only be costly but can also take up much needed computer and network time and resources. In some examples, the monitoring and testing of the systems not only cost time and effort, but the presence of monitoring software by itself could cause the slowdown that is to be avoided in the first place.

A communication system for process management, as outlined in FIGS. 1 and 2, can resolve these issues (and others). Communication systems 100a and 100b can be configured for performance monitoring in high performance computer clusters. In an example, communication systems 100a and 100b can be configured to record the last node completing a process, communicating data, or otherwise satisfying a condition and determine if a node or nodes are consistently late over multiple processes or calculations. This information can be used as a flag or indicator that something may be wrong with the network and in particular with the identified node or nodes.

Communication systems 100a and 100b can be configured as light weight performance monitoring and can be implemented without impacting, or slightly impacting, either operating systems (OS) or user applications. Current systems may provide information irrelevant of an actual error condition whereas communication systems 100a and 100b can be configured to detect a late node that may be slowing down the network. The node may be late for a multitude of reasons, but for a cluster administration, the root cause is of secondary importance compared to detecting a specific node or nodes that are consistently slowing down the network. In addition, some current solutions rely on statistics, in the case of multiple runs of different projects, the detection of a late node or nodes is agnostic to distribution errors of single processes. Detecting a late node or nodes can also help a programmer to find errors in workload distribution if the analyses is applied to a single process.

Most projects, processes, applications, etc. running on high performance computing clusters use message passing interface (MPI). MPI is a standardized and portable message passing system to function on a wide variety of parallel computing architectures. MPI includes so called collective operations like MPI_Reduce( ) or MPI_Barrier( ) and during these operations many (possibly all) of the nodes in the network, or those that are involved in the calculations, take part.

In an example, communication system 100 can be configured such that the MPI layer can determine the identity of the last node to complete a calculation or process and inform a central monitoring system (e.g., counter engine 110) of the last node. This is especially effective when combined with a fabric like OmniPath (OPA). While a single event may have no meaning by itself, recording nodes or processes that are consistently late over multiple calculations allows a system administrator to detect a slow or defect node or nodes.

MPI projects and processes, in their most basic forms, consist of 4 parts, Initialization, calculation of the problem distributed over every node, reduction of the problem to a single solution, and finalization. Each initialization engine 122a-122d can be configured to perform the initialization for their respective node 116a-116d (e.g., initialization engine 112a is associated with node 116a). Each calculation engine 124a-124d can be configured to perform the process for their respective node 116a-116d (e.g., calculation engine 124a is associated with node 116a). Each reduction engine 126a-126d can be configured to perform the reduction of the data created by the calculation engine or received data for involved nodes 116a-116d (e.g., reduction engine 126a is associated with node 116a). Each finalization engine 128a-128d can be configured to perform the finalization of the data for their respective node 116a-116d (e.g., finalization engine 128a is associated with node 116a).

During startup, a project or process is typically executed on every node in parallel and dynamically linked with an MPI library (e.g., communication library 120). Calculation and reduction parts are often executed more than once, especially during reduction phases where node and processes running on the nodes have to wait for each other to synchronize and exchange information. At such times one node will always be last. The MPI library, as a middleware layer, will be aware of this situation and can report the last node to a central management unit (e.g., counter engine 110). In a cluster, a fabric manager can be the central management unit.

The information can later be retrieved and analyzed both taking into accounts “per project” and “per time period” behavior. Imbalances in the per project data can be valuable for users and administrators to create better workloads. Imbalances in the per time period data can become valuable to the system administrator, especially when checking behavior over different types of workloads. Nodes that consistently perform poorly will stand out and can be taken down and investigated more closely. The reporting can be in form of raw numbers (e.g., node 192 was last 15367 times in the last project or chosen time period). As the numbers can be very large, the reporting can be also in the form of a relative output (e.g., in the last project or time period, node 192 was last 99% of the time).

While a single measurement may not have much value, synchronization points often occur even in a single project. If all nodes are performing similar, and the coding of the process or project created a correctly balanced workload, on a next iteration of the process or project, a node different than the previous node reported as last will be the slowest and a new node will be reported as last. As many multi node MPI functions employ tree structures to relay messages, a tight integration of this feature into the network fabric may be used to avoid overhead.

Cluster reporting to the administrator could be relatively easily integrated into the network manager 106. During the prologue of a project or process, the current counters for the nodes used could be queried from a network manager (e.g., network manager 106), at the end of the project or process new counters could be taken and the differences presented to the administer in a relatively easy to read form. Communication system 100 can be configured to allow for an extremely lightweight performance measurement independent of system type or workload.

Turning to the infrastructure of FIGS. 1 and 2, generally, communication systems 100a and 100b may be implemented in any type or topology of networks. Networks 102a and 102b each represents a series of points or nodes of interconnected communication paths for receiving and transmitting packets of information that propagate through communication systems 100a and 100b. Networks 102a and 102b offer a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication systems 100a and 100b, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)), InfiniBand remote direct memory access (RDMA), InfiniBand verbs, Direct Access Programming Library (DAPL), Performance Scaled Messaging (PSM). Additionally, radio signal communications over a cellular network may also be provided in communication systems 100a and 100b. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, nodes 104a-104e, network managers 106, electronic devices 112, and nodes 116a-116d are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication systems 100a and 100b, each of nodes 104a-104e, network managers 106, electronic devices 112, and nodes 116a-116d can include memory elements for storing information to be used in the operations outlined herein. Each of nodes 104a-104e, network managers 106, electronic devices 112, and nodes 116a-116d may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication systems 100a and 100b could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication systems 100a and 100b, such as nodes 104a-104e, network managers 106, electronic devices 112, and nodes 116a-116d may include software modules (e.g., data processing engines 108a-108e, counter engine 110, initialization engines 122a-122d, calculation engine 124a-124d, reduction engine 126a-126d, finalization engine 128a-128d, etc.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of nodes 104a-104e, network managers 106, electronic devices 112, and nodes 116a-116d may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’ Electronic device 112 can be a network element and include end user devices, for example, desktop computers, laptop computers, mobile devices, personal digital assistants, smartphones, tablets, or other similar devices.

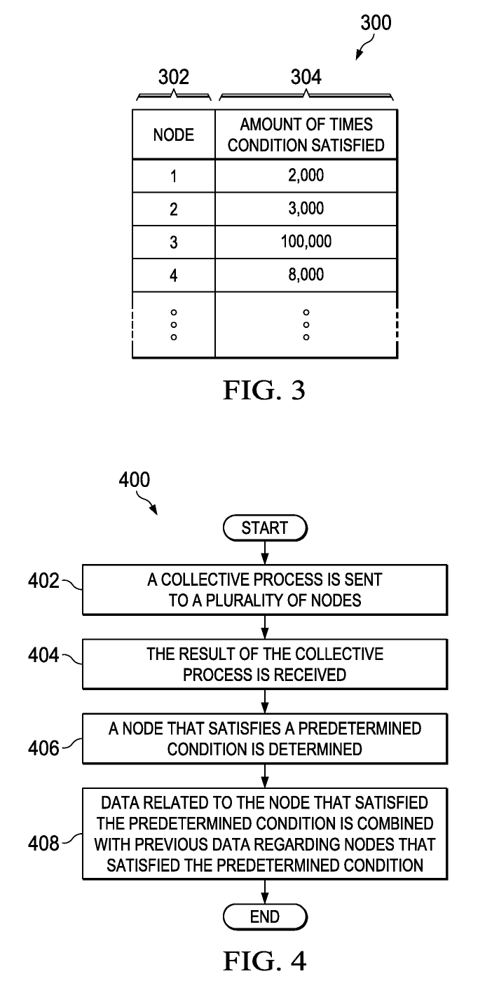

Turning to FIG. 3, FIG. 3 is a simplified block diagram illustrating example details of communication systems 110a and 100b for performance monitoring, in accordance with an embodiment of the present disclosure. As illustrated in FIG. 3, a table 300 can include a node column 302 and an amount of times condition was satisfied column 304. Data in table 300 may be determined by network manger 106 using counter engine 110 and stored in counter database 130 or the data may be determined by one or more calculation engines 124a-124d or finalization engine 128a-128d. Table 300 can be used to determine if a node consistently satisfies a condition. For example, if a process was run hundreds of thousands of times, table 300 can indicate that node 3 (e.g., node 116c) was late 100,000 times. The data can be used to determine that node 3 is consistently late and a problem needs to be addressed. In another example, table 300 can be used to determine a node or nodes that finished a task after a predetermined amount of time expired.

Turning to FIG. 4, FIG. 4 is an example flowchart illustrating possible operations of a flow 400 that may be associated with performance monitoring, in accordance with an embodiment. In an embodiment, one or more operations of flow 400 may be performed by data processing engines 108a-108e, counter engine 110, initialization engines 122a-122d, calculation engine 124a-124d, reduction engine 126a-126d, and/or finalization engine 128a-128d. At 402, a collective process is sent to a plurality of nodes. At 404, the result of the collective process is received. At 406, a node that satisfies a predetermined condition is determined. For example, the predetermined condition can be the node that was the last node to finish the collective process. At 408, data related to the node that satisfied the predetermined condition is combined with previous data regarding nodes that satisfied the predetermined condition. For example, data such as an identifier that identifies the node that was the last node to finish the collective process is combined with previous data that identifies previous nodes that were the last node to finish the collective process. The data can be organized into a table similar to table 300 illustrated in FIG. 3 and used to determine if a particular node is a node that systematically satisfies the predetermined condition (e.g., a node that is systematically the last node to finish the collective process).

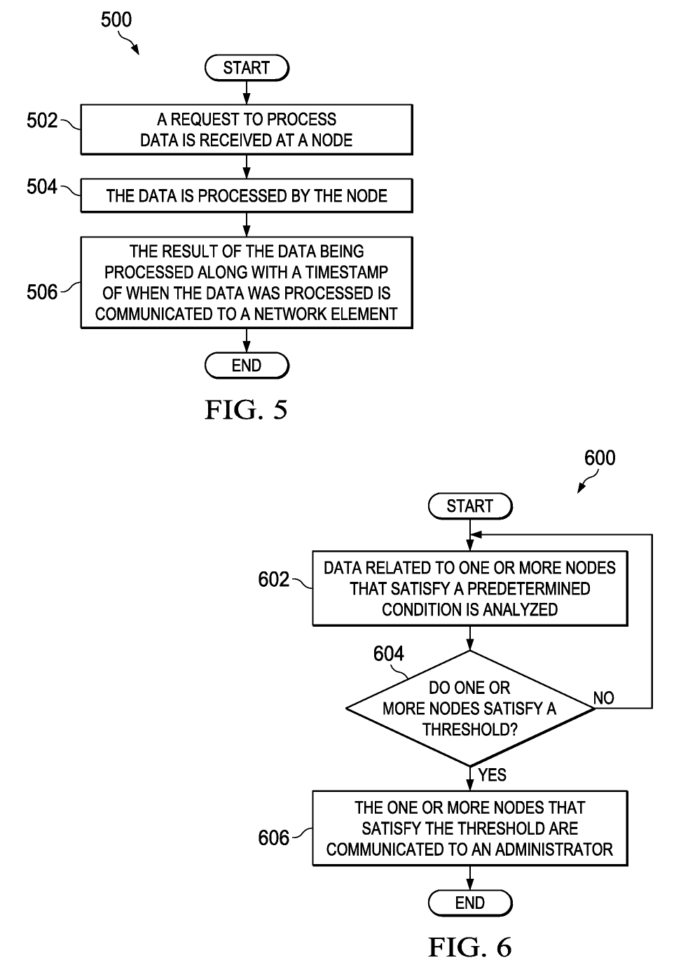

Turning to FIG. 5, FIG. 5 is an example flowchart illustrating possible operations of a flow 500 that may be associated with process management, in accordance with an embodiment. In an embodiment, one or more operations of flow 500 may be performed by data processing engines 108a-108e, counter engine 110, initialization engines 122a-122d, calculation engine 124a-124d, reduction engine 126a-126d, and/or finalization engine 128a-128d. At 502, a request to process data is received at a node. At 504, the data is processed by the node. At 506, the result of the data being processed along with a timestamp of when the data was process is communicated to a network element.

Turning to FIG. 6, FIG. 6 is an example flowchart illustrating possible operations of a flow 600 that may be associated with process management, in accordance with an embodiment. In an embodiment, one or more operations of flow 600 may be performed by data processing engines 108a-108e, counter engine 110, initialization engines 122a-122d, calculation engine 124a-124d, reduction engine 126a-126d, and/or finalization engine 128a-128d. At 602, data related to one or more nodes that satisfy a predetermined condition is analyzed. At 604, the system determines if one or more nodes satisfy a threshold. If one or more nodes do not satisfy a threshold, then the system returns to 602 where data related to one or more nodes that satisfy a predetermined condition is analyzed. If one or more nodes satisfy a threshold, then the one or more nodes that satisfy the threshold are communicated to an administrator, as in 606. For example, data related to one or more nodes that are the last node to complete a process can be analyzed. If one or more of the nodes are the last node to complete the process a predetermined number of times or above a predetermined percentage, then the one or more nodes that are the last node to complete the process is communicated to an administrator. The administrator can take remedial action regarding the one or more nodes that satisfied the condition.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication systems 100a and 100b and their teachings are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the operations in the preceding flow diagrams (i.e., FIGS. 4-6) illustrate only some of the possible correlating scenarios and patterns that may be executed by, or within, communication systems 100a and 100b. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication systems 100a and 100b have been illustrated with reference to particular elements and operations that facilitate the communication process, these elements and operations may be replaced by any suitable architecture, protocols, and/or processes that achieve the intended functionality of communication systems 100a and 100b.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example C1 is at least one machine readable storage medium having one or more instructions that when executed by at least one processor, cause the at least one processor to send a collective process to a plurality of nodes, receive data related to the plurality of nodes after the collective process is completed, and analyze the data related to the plurality of nodes to determine if one or more nodes satisfies a predetermined condition.

In Example C2, the subject matter of Example C1 can optionally include where the instructions, when executed by the by at least one processor, further cause the at least one processor to combine data related to the one or more nodes that satisfied the predetermined condition with previously received data related to previous one or more nodes that satisfied the predetermined condition.

In Example C3, the subject matter of any one of Examples C1-C2 can optionally include where the predetermined condition is a last node to complete the collective process.

In Example C4, the subject matter of any one of Examples C1-C3 can optionally include where the instructions, when executed by the by at least one processor, further cause the at least one processor to flag one or more nodes that satisfy a threshold, where the threshold is related to the predetermined condition.

In Example C5, the subject matter of any one of Examples C1-C4 can optionally include where the data related to the plurality of nodes is received with the results of the collective process.

In Example C6, the subject matter of any one of Examples C1-05 can optionally include where the data includes a timestamp of when each node in the plurality of nodes completed a portion of the collective process.

In Example C7, the subject matter of any one of Examples C1-C6 can optionally include where the data related to the plurality of nodes is communicated using a message passing interface.

In Example A1, an apparatus can include memory, at least one processor, and a counter engine configured to send a collective process to a plurality of nodes, receive data related to the plurality of nodes after the collective process is completed, and analyze the data related to the plurality of nodes to determine if one or more nodes satisfies a predetermined condition.

In Example, A2, the subject matter of Example A1 can optionally include where the counter engine is further configured to combine data related to the one or more nodes that satisfied the predetermined condition with previously received data related to previous one or more nodes that satisfied the predetermined condition.

In Example A3, the subject matter of any one of Examples A1-A2 can optionally include where the predetermined condition is a last node to complete the collective process.

In Example A4, the subject matter of any one of Examples A1-A3 can optionally include where the counter engine is further configured to flag one or more nodes that satisfy a threshold, where the threshold is related to the predetermined condition.

In Example A5, the subject matter of any one of Examples A1-A4 can optionally include where the data related to the plurality of nodes is received with the results of the collective process.

Example M1 is a method including sending a collective process to a plurality of nodes, receiving data related to the plurality of nodes after the collective process is completed, and analyzing the data related to the plurality of nodes to determine if one or more nodes satisfies a predetermined condition.

In Example M2, the subject matter of Example M1 can optionally include combining data related to the one or more nodes that satisfied the predetermined condition with previously received data related to previous one or more nodes that satisfied the predetermined condition.

In Example M3, the subject matter of any one of the Examples M1-M2 can optionally include where he predetermined condition is a last node to complete the collective process.

In Example M4, the subject matter of any one of the Examples M1-M3 can optionally include flagging one or more nodes that satisfy a threshold, where the threshold is related to the predetermined condition.

In Example M5, the subject matter of any one of the Examples M1-M4 can optionally include where the data related to the plurality of nodes is received with the results of the collective process.

In Example M6, the subject matter of any one of Examples M1-M5 can optionally include where the data related to the plurality of nodes is communicated using a message passing interface.

Example S1 is a system for performance monitoring, the system can include memory, one or more processors, and a counter engine. The counter engine can be configured to send a collective process to a plurality of nodes, receive data related to the plurality of nodes after the collective process is completed, and analyze the data related to the plurality of nodes to determine if one or more nodes satisfies a predetermined condition.

In Example S2, the subject matter of Example S1 can optionally include where the counter engine is further configured to combine data related to the one or more nodes that satisfied the predetermined condition with previously received data related to previous one or more nodes that satisfied the predetermined condition.

In Example S3, the subject matter of any one of the Examples S1-S2 can optionally include where the predetermined condition is a last node to complete the collective process.

In Example S4, the subject matter of any one of the Examples S1-S3 can optionally include where the counter engine is further configured to flag one or more nodes that satisfy a threshold, where the threshold is related to the predetermined condition.

In Example S5, the subject matter of any one of the Examples S1-S4 can optionally include where the data related to the plurality of nodes is received with the results of the collective process.

In Example S6, the subject matter of any one of the Examples S1-S5 can optionally include where the data includes a timestamp of when each node in the plurality of nodes completed a portion of the collective process.

In Example S7, the subject matter of any one of the Examples S1-S6 can optionally include where the data related to the plurality of nodes is communicated using a message passing interface.

Example AA1 is an apparatus including means for sending a collective process to a plurality of nodes, means for receiving data related to the plurality of nodes after the collective process is completed, and means for analyzing the data related to the plurality of nodes to determine if one or more nodes satisfies a predetermined condition.

In Example AA2, the subject matter of Example AA1 can optionally include means for combining data related to the one or more nodes that satisfied the predetermined condition with previously received data related to previous one or more nodes that satisfied the predetermined condition.

In Example AA3, the subject matter of any one of Examples AA1-AA2 can optionally include where the predetermined condition is a last node to complete the collective process.

In Example AA4, the subject matter of any one of Examples AA1-AA3 can optionally include means for flagging one or more nodes that satisfy a threshold, where the threshold is related to the predetermined condition.

In Example AA5, the subject matter of any one of Examples AA1-AA4 can optionally include where the data related to the plurality of nodes is received with the results of the collective process.

In Example AA6, the subject matter of any one of Examples AA1-AA5 can optionally include where the data includes a timestamp of when each node in the plurality of nodes completed a portion of the collective process.

In Example AA7, the subject matter of any one of Examples AA1-AA6 can optionally include where the data related to the plurality of nodes is communicated using a message passing interface.

Example X1 is a machine-readable storage medium including machine-readable instructions to implement a method or realize an apparatus as in any one of the Examples A1-A5, M1-M6, or AA1-AA7. Example Y1 is an apparatus comprising means for performing of any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable medium comprising one or more instructions that when executed by at least one processor, cause the at least one processor to:
send a collective process to a plurality of nodes;
receive data related to the plurality of nodes after the collective process is completed; and
analyze the data related to the plurality of nodes to determine if one or more nodes satisfies a predetermined condition.

2. The at least one machine readable medium of claim 1, further comprising one or more instructions that when executed by the at least one processor, further cause the at least one processor to:
combine data related to the one or more nodes that satisfied the predetermined condition with previously received data related to previous one or more nodes that satisfied the predetermined condition.

3. The at least one machine readable medium of claim 2, wherein the predetermined condition is a last node to complete the collective process.

4. The at least one machine readable medium of claim 2, further comprising one or more instructions that when executed by the at least one processor, further cause the at least one processor to:
flag one or more nodes that satisfy a threshold, wherein the threshold is related to the predetermined condition.

5. The at least one machine readable medium of claim 1, wherein the data related to the plurality of nodes is received with the results of the collective process.

6. The at least one machine readable medium of claim 1, wherein the data includes a timestamp of when each node in the plurality of nodes completed a portion of the collective process.

7. The at least one machine readable medium of claim 1, wherein the data related to the plurality of nodes is communicated using a message passing interface.

8. An apparatus comprising:
memory;
at least one processor; and
a counter engine configured to:
send a collective process to a plurality of nodes;
receive data related to the plurality of nodes after the collective process is completed; and
analyze the data related to the plurality of nodes to determine if one or more nodes satisfies a predetermined condition.

9. The apparatus of claim 8, wherein the counter engine is further configured to:
combine data related to the one or more nodes that satisfied the predetermined condition with previously received data related to previous one or more nodes that satisfied the predetermined condition.

10. The apparatus of claim 9, wherein the predetermined condition is a last node to complete the collective process.

11. The apparatus of claim 9, wherein the counter engine is further configured to:
flag one or more nodes that satisfy a threshold, wherein the threshold is related to the predetermined condition.

12. The apparatus of claim 8, wherein the data related to the plurality of nodes is received with the results of the collective process.

13. A method comprising:
sending a collective process to a plurality of nodes;
receiving data related to the plurality of nodes after the collective process is completed; and
analyzing the data related to the plurality of nodes to determine if one or more nodes satisfies a predetermined condition.

14. The method of claim 13, further comprising:
combining data related to the one or more nodes that satisfied the predetermined condition with previously received data related to previous one or more nodes that satisfied the predetermined condition.

15. The method of claim 14, wherein the predetermined condition is a last node to complete the collective process.

16. The method of claim 13, further comprising:
flagging one or more nodes that satisfy a threshold, wherein the threshold is related to the predetermined condition.

17. The method of claim 13, wherein the data related to the plurality of nodes is received with the results of the collective process.

18. The method of claim 13, wherein the data related to the plurality of nodes is communicated using a message passing interface.

19. A system for performance monitoring, the system comprising:
memory;
one or more processors; and
a counter engine configured to:
send a collective process to a plurality of nodes;
receive data related to the plurality of nodes after the collective process is completed; and
analyze the data related to the plurality of nodes to determine if one or more nodes satisfies a predetermined condition.

20. The system of claim 19, wherein the counter engine is further configured to:
combine data related to the one or more nodes that satisfied the predetermined condition with previously received data related to previous one or more nodes that satisfied the predetermined condition.

21. The system of claim 20, wherein the predetermined condition is a last node to complete the collective process.

22. The system of claim 20, wherein the counter engine is further configured to:
flag one or more nodes that satisfy a threshold, wherein the threshold is related to the predetermined condition.

23. The system of claim 19, wherein the data related to the plurality of nodes is received with the results of the collective process.

24. The system of claim 19, wherein the data includes a timestamp of when each node in the plurality of nodes completed a portion of the collective process.

25. The system of claim 19, wherein the data related to the plurality of nodes is communicated using a message passing interface.
